(19) United States
(12) Patent Application Publication
(10) Pub. No.: US 2014/0317416 A1
(43) Pub. Date: Oct. 23, 2014

(54) METHOD FOR INPUTTING ACCOUNTS AND PASSWORDS TO COMPUTER OR TELECOM DEVICE VIA AN AUDIO INTERFACE

(71) Applicant: Chi-Pei Wang, Hsinchu City (TW)

(72) Inventor: Chi-Pei WANG, Hsinchu City (TW)

(21) Appl. No.: 14/193,338

(22) Filed: Feb. 28, 2014

(30) Foreign Application Priority Data
Apr. 19, 2013 (TW) 102113885

(51) Int. Cl. G06F 21/34

(52) U.S. Cl. CPC G06F 21/34
USPC 713/185

(57) ABSTRACT

A method for inputting accounts and passwords to a computer or telecom device via an audio interface via an audio jack. The method includes the following steps: fabricating a data storage device with audio interface; storing an account and password into the data storage device; setting a software capable of being implemented on the computer or telecom device; said software has the functions of data encryption and decryption as well as data access via the audio interface; and connecting the data storage device via the audio interface to the audio jack of the computer or telecom device. When the software requests the user to input accounts and passwords, the accounts and passwords in the data storage device could be obtained and then decrypted via the audio jack and audio interface, thus finishing the input of the users accounts and passwords by non-keying means.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an input method of accounts and passwords of a computer or telecom device, and more particularly to an innovative one which is designed to enable direct data transmission and non-keying input, via an audio interface.

2. Description of Related Art Including Information Disclosed Under 37 CFR 1.97 and 37 CFR 1.98.

Due to the original architecture of a personal computer, any software could be used to access the keying data of computers without being discovered by the users. In this aspect, keylogger or spy software is a tool to illegally steal personal accounts or passwords with such characteristics. In the past, there was a shortage of encrypted keyboards in the market, so the treasures or scores of on-line game players were often stolen, or their accounts or passwords of on-line banks were logged, leading to the loss in money.

Currently, multiple anti-logging encrypted products have been developed for the benefit of consumers, but some shortcomings are still observed during actual applications, roughly owing to the fact that the users have to purchase encrypted hardware (e.g. encrypted keyboard, encrypted mouse and connecting lines) or encrypted software programs for accessing the encryption functions. However, such encrypted hardware cannot be easily carried, leading to greater limitations. Moreover, the input procedures for accounts and passwords could be finished only by slow keying or touch control, and deemed as crucial factors for logging by hijackers. On the other hand, many users may store their accounts and passwords on PCs or mobile phones, increasing the vulnerability of being stolen by the hijackers. Hence, there is still much room for improvement of conventional anti-logging, encryption computer products.

On the other hand, smart phones and tablet computers also enable on-line transactions via networking with an input interface such as soft keyboard for touch screen control. With the growing popularity of smart phones and tablet computers, various kinds of malicious software are used to attack them in the lack of protection of the user's input data (especially the accounts, passwords and credit and numbers) from the soft keyboards. Notwithstanding the functions of touch control screen chips could be modified to realize safe inputs of hardware, it is difficult to widely apply this new technology since the touch control screen manufacturers are reluctant to increase their chip cost in absence of numerous market demands. For these reasons, other peripherals shall be incorporated into existing smart phones and tablet computers.

Furthermore, there are currently available with USB-based data storage devices (i.e.: USB thumb drivers, or USB walking drivers). Some manufacturers also fabricate them into to key-shaped pattern, allowing the users to place them together with keys. Though USB walking drivers could also store common accounts and passwords for portable data transmission, such USB walking drivers are only suitable for PCs, not for smart phones and tablet computers, due to the compatibility of hardware and software. Besides, it is technically impossible to modify directly USB walking drivers into audio interfaces, owing to the fact that the signal speed of audio interfaces is very slow and their power supply is extremely limited, without mentioning too high power consumption of USB walking drivers. Another problem is: UBS interface cannot be directly used by iPhone and iPad of Apple Corp., so different design techniques are required to store digital data via audio interface.

Given growing number of malicious software against smart phones and tablet computers, the general public intend to store accounts, passwords and credit card numbers, into the storage space or cloud space of smart phones and tablet computers, and such important personal data are exposed to certain risks, so it is a crucial issue to develop an innovative product with higher convenience and security.

Thus, to overcome the aforementioned problems of the prior art, it be would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the technical characteristics of the present invention where a accounts and passwords are inputted via the audio interface, the users' accounts and passwords could be easily carried, namely, the data storage device 20 can be carried. Referring to FIG. 4, said audio interface 21 allows to transmit data by connecting with the standard audio jack 13 of an existing computer 11 and telecom device 12 (e.g.: mobile phones and tablet computers) (note: said audio jack is of a transmission interface commonly used by almost all computers and telecom devices), so the users' accounts and passwords could be directly transmitted to the computer or telecom device, thus saving the time-consuming procedures of manual keying or input of accounts and passwords via touch control, and preventing possible neglect of accounts and passwords for simpler, quicker and easier input. Meanwhile this could alleviate greatly the probability and risks of logging by hijackers. On the other hand, as the users accounts and passwords are stored in the portable cloud key device A that could be removed immediately upon utilization, it is not required to store the accounts and passwords in the computer or telecom device, thus preventing efficiently the theft or attack by hijackers. Further, with the adding of encryption design of the software 40, anti-logging effect could be achieved for the input of accounts and passwords. To sum up, the present invention enables to prevent logging and protect accounts and passwords in addition to its technical features including: easier convenience in operation.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a text block chart of a preferred embodiment of the method disclosed in the present invention.

FIG. 2 is a perspective view of the preferred embodiment of the data storage device of the present invention.

FIG. 3 is a block chart of the preferred embodiment of the method showing the connecting relationship and operating conditions of the components.

FIG. 4 is a perspective view of the present invention wherein the data storage device could be inserted into the computer or telecom device.

FIG. 5 is a text Hock chart of another preferred embodiment of the method disclosed in the present invention.

### DETAILED DESCRIPTION OF THE INVENTION

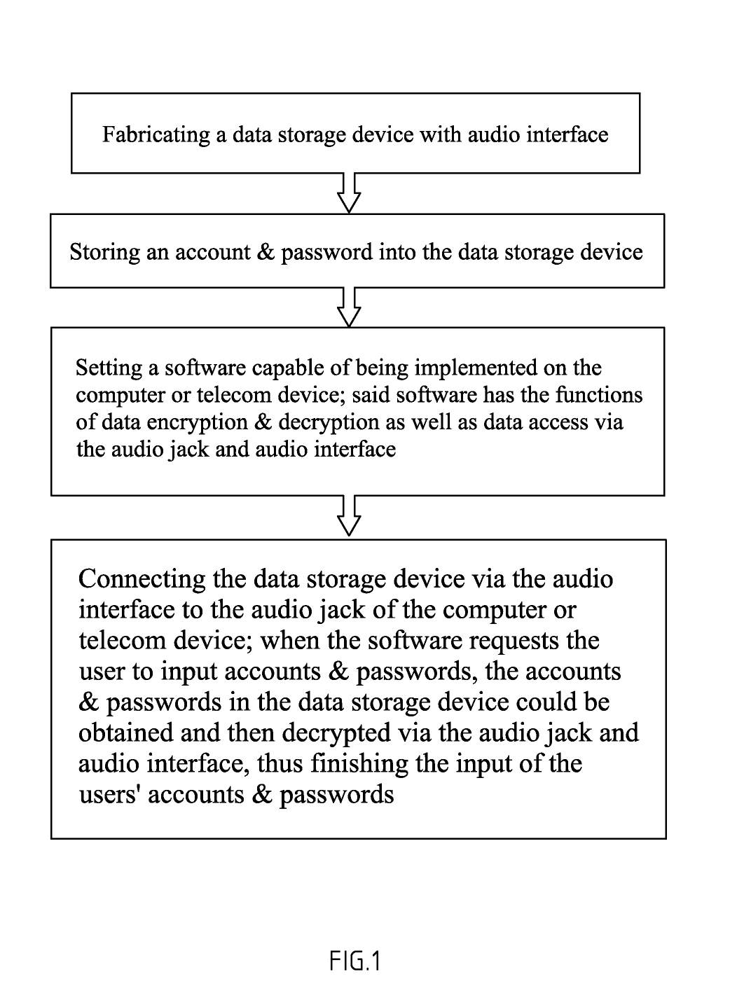

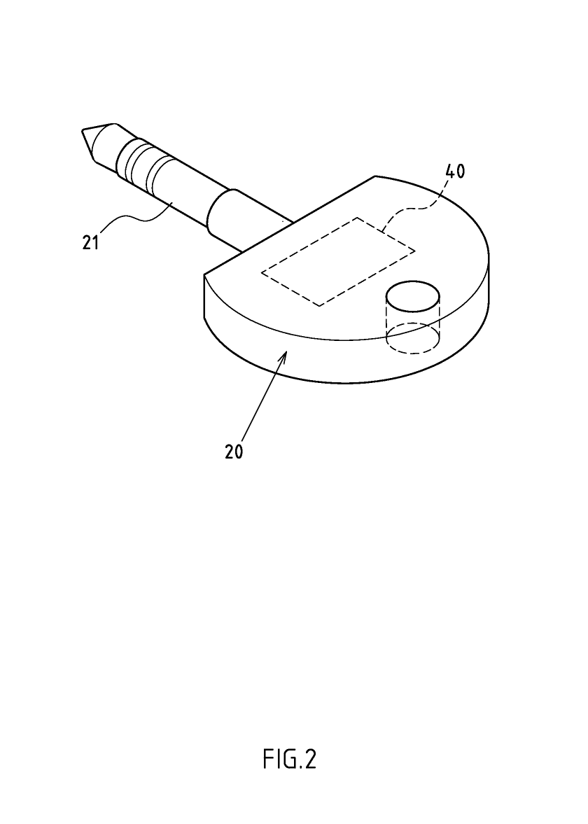

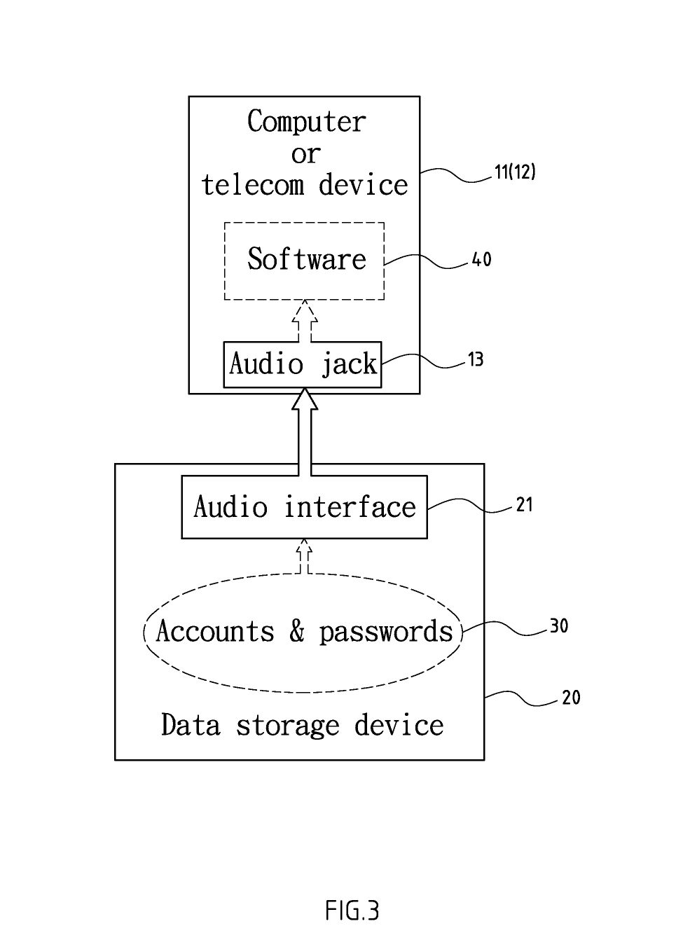

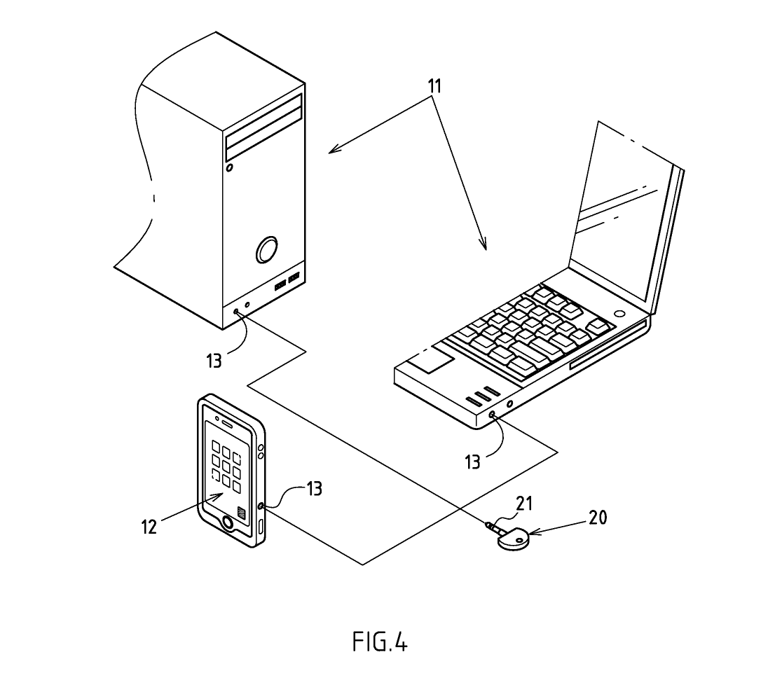

FIGS. 1-4 depict preferred embodiments of a method of the present invention for inputting accounts and passwords via audio interface, which, however, are provided for only explanatory objective for patent claims. Said method is used to directly transmit the users accounts and passwords to a computer 11 or telecom device 12 (e.g.: mobile phone or tablet computer) with audio jack 13. The method comprises the following steps:
a. fabricating a data storage device 20 (note: marked by FIG. 2) with audio interface 21;
b. storing an account and password 30 into the data storage device 20;
c. setting a software 40 capable of being implemented on the computer 11 or telecom device 12; said software 40 has the functions of data encryption and decryption as well as data access via the audio jack 13 and audio interface 21 (note: generally a jack);
d. connecting the data storage device 20 via the audio interface 21 to the audio jack 13 of the computer 11 or telecom device 12; when the software 40 requests the user to input accounts and passwords, the accounts and passwords 30 in the data storage device 20 could be obtained, and then decrypted via the audio jack 13 and audio interface 21, thus finishing the input of the users' accounts and passwords by non-keying means; meanwhile encryption could be conducted via the software to realize safe login by the accounts and passwords.

In this preferred embodiment, upon completion of input of accounts and passwords, the audio plug 21 could be pulled out of the audio jack 13, thus reducing the opportunities of hijacking by eliminating accessibility of the accounts and passwords.

Of which, said software 40 is designed into a near-end application software or a far-end servo software.

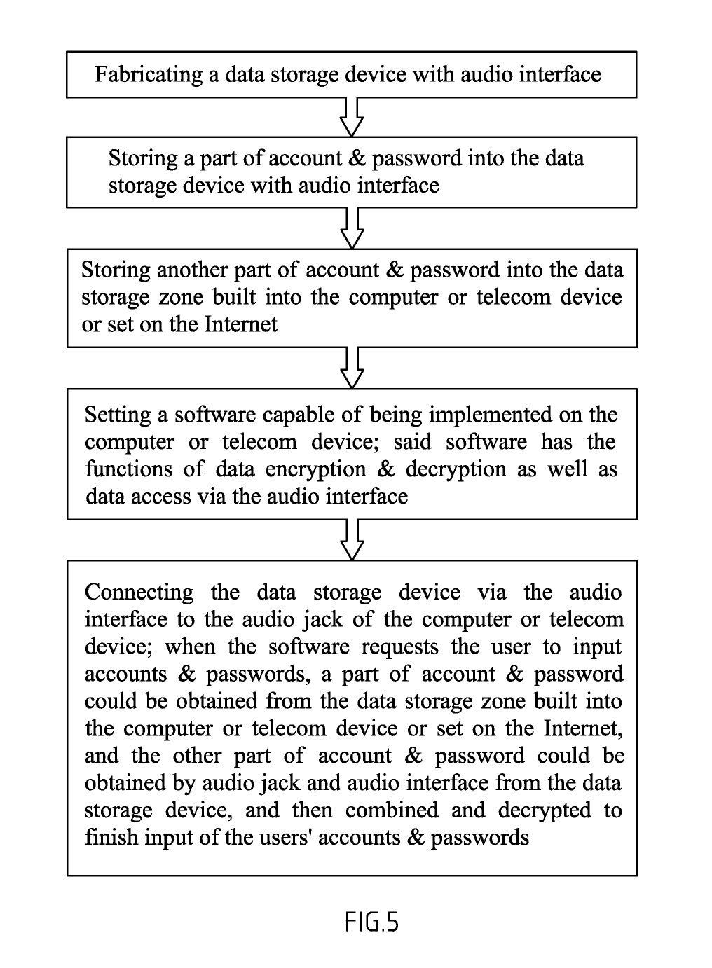

FIG. 5 depicts another preferred embodiment of a method of the present invention wherein accounts and passwords are inputted via the audio interface to the computer or telecom device. FIGS. 1-4 depict the variation diagrams of the preferred embodiments, wherein main components comprise of the following methods:
a. fabricating a data storage device 20 with audio interface 21;
b. storing a part of account and password 30 into the data storage device 20 with audio Interface 21;
c. storing another part of account and password 30 into the data storage zone built into the computer or telecom device or set on the Internet (note: not shown graphically);
d. setting a software 40 capable of being implemented on the computer 11 or telecom device 12, said software 40 has the functions of data encryption and decryption as well as data access via the audio interface 21;
e. connecting the data storage device 20 via the audio interface 21 to the audio jack 13 of the computer 11 or telecom device 12; when the software 40 requests the user to input accounts and passwords, a part of account and password 30 could be obtained from the data storage zone built into the computer 11 or telecom device 12 or set on the Internet, and the other part of account and password 30 could be obtained by audio jack 13 and audio interface 21 from the data storage device 20, and then combined and decrypted to finish input of the users accounts and passwords; with this method, the accounts and passwords could be inputted by non-keying means for safe login by the accounts and passwords.

The difference between this preferred embodiment and those disclosed in FIGS. 1-4 only lies in that, when the software 40 requests the user to input accounts and passwords, a part of account and password 30 could be obtained from the data storage zone built into the computer 11 or telecom device 12 or set on the Internet, and the other part of account and password 30 could be obtained by audio jack 13 and audio interface 21 from the data storage device 20, and then combined and decrypted. These technical characteristics and advantages could efficiently prevent hijacking of accounts and passwords stored in to the computer or telecom device, and also avoid theft against the data storage device 20. Hence, it is necessary to combine the computer 11 or telecom device 12 with the data storage device 20 to minimize the possibility of hijacking of the accounts and passwords.

In the preferred embodiment disclosed in FIG. 5, the data storage zone built into said computer or telecom device or set on the Internet is either a rear-end or a far-end data storage device, or even a mixed one combining rear-end and far-end.

1. A method for inputting accounts and passwords to a computer or telecom device via an audio interface, the method comprising:
a) fabricating a data storage device with an audio interface;
b) storing an account and password into the data storage device;
c) setting a software capable of being implemented on the computer or telecom device; said software has the functions of data encryption and decryption as well as data access via the audio interface; and
d) connecting the data storage device via the audio interface to the audio jack of the computer or telecom device; when the software requests the user to input accounts and passwords, the accounts and passwords in the data storage device could be obtained and then decrypted via the audio jack and audio interface, thus finishing the input of the users' accounts and passwords by non-keying means; meanwhile encryption could be conducted via the software.

2. The method defined in claim 1, wherein said software is designed into a near-end application software or a far-end servo software.

3. A method for inputting accounts and passwords to a computer or telecom device via an audio interface, the method comprising:
a) fabricating a data storage device with an audio interface;
b) storing a part of an account and password into the data storage device with audio interface;
c) storing another part of an account and password into the data storage zone built into the computer or telecom device or set on the Internet;
d) setting a software capable of being implemented on the computer or telecom device; said software has the functions of data encryption and decryption as well as data access via the audio interface; and
e) connecting the data storage device via the audio interface to the audio jack of the computer or telecom device; when the software requests the user to input accounts and passwords, a part of account and password could be obtained from the data storage zone built into the computer or telecom device or set on the Internet, and the other part of account and password could be obtained by audio jack and audio interface from the data storage device, and then combined and decrypted to finish input of the users' accounts and passwords.

4. The method defined in claim 3, wherein said software is either a rear-end or a far-end data software, or a mixed one combining rear-end and far-end.

5. The method defined in claim 3, wherein said data storage zone built into said computer or telecom device or set on the Internet is either a rear-end or a far-end data storage device, or a mixed one combining rear-end and far-end.
